(19) United States
(12) Patent Application Publication
(10) Pub. No.: US 2025/0269874 A1
(43) Pub. Date: Aug. 28, 2025

(54) PASSAGE POINT GENERATION APPARATUS

(71) Applicant: Mitsubishi Electric Corporation, Tokyo (JP)

(72) Inventor: Yuki YOSHIDA, Tokyo (JP)

(73) Assignee: Mitsubishi Electric Corporation, Tokyo (JP)

(21) Appl. No.: 18/858,752

(22) PCT Filed: May 11, 2022
(86) PCT No.: PCT/JP2022/019950

§ 371 Date: Oct. 22, 2024

(51) Int. Cl. B60W 60/00; B60W 30/18; B60W 50/00

(52) U.S. Cl. CPC B60W 60/0011; B60W 30/18009; B60W 50/0098; B60W 2552/50; B60W 2556/45

(57) ABSTRACT

The present disclosure relates to a passage point generation apparatus. A passage point generation apparatus generating a passage point which a moving body should reach, including: a target state candidate generation part calculating a plurality of target state candidates including at least a state amount of a position based on surrounding environment information of the moving body and a state amount of the moving body; and a local target state generation part calculating a local target state as a local target state reachable in any of the plurality of target state candidates in an intermediate point of a trajectory toward a surrounding area of the plurality of target state candidates and outputting the local target state as the passage point.

### TECHNICAL FIELD

The present disclosure relates a passage point generation apparatus generating a passage point for achieving an automatic driving of a vehicle, for example.

### BACKGROUND ART

Recently, development of an autonomous moving body such as a self-driving automobile and a self-driving autonomous transfer carrier proceeds. Traveling of these autonomous moving bodies is controlled so that the autonomous moving bodies reaches a target state including a determined target position. However, a state where the autonomous moving body cannot pass the target position is recognized by information obtained by an external sensor, for example, only after the autonomous moving body approaches the target position depending on circumstances. For example, in a situation of passing a tollgate, when a target vehicle selects a target tollgate while the target vehicle has a sufficient distance from the tollgate, considered is a situation where the target tollgate is not open or a broken vehicle is parked in the tollgate only after the target vehicle approaches the initial target tollgate. The target position needs to be changed in such a situation. For example, as disclosed in Patent Document 1, developed is a technique of achieving a more preferred passage of a gate by correcting a selected gate in accordance with dynamic information obtained by a sensor.

### PRIOR ART DOCUMENTS

### Patent Document(s)

Patent Document 1: International Publication No. 2018/142561

### SUMMARY

### Problem to be Solved by the Invention

Proposed in Patent Document 1 are a technique of selecting a first gate from a plurality of gates based on static information, and subsequently correcting a selection result of the first gate to a second gate based on dynamic information and adding correction processing to a gate selection result, thereby selecting more preferred gate and a vehicle control system increasing a passage probability of a gate.

However, when the target gate is corrected from the first gate to a gate far away from the first gate on a way to the first gate, or when the target gate is corrected to the other gate immediately before reaching the first gate, there occur a problem that sudden steering wheel control needs to be performed to correct a trajectory in a vehicle or a trajectory along which the vehicle can reach a gate after correction cannot be found.

The present disclosure therefore has been made to solve the above problems, and it is an object to provide a passage point generation apparatus capable of reaching a changed target state without a sudden correction of a trajectory even in a state where there is no choice but to change the target state.

### Means to Solve the Problem

A passage point generation apparatus according to the present disclosure is a passage point generation apparatus generating a passage point which a moving body should reach, including: a target state candidate generation part calculating a plurality of target state candidates including at least a state amount of a position based on surrounding environment information of the moving body and a state amount of the moving body; and a local target state generation part calculating a local target state as a local target state reachable in any of the plurality of target state candidates in an intermediate point of a trajectory toward a surrounding area of the plurality of target state candidates and outputting the local target state as the passage point.

### Effects of the Invention

According to the passage point generation apparatus according to the present disclosure, the local target state as the target state reachable in any of the plurality of target state candidates is calculated in the intermediate point of the trajectory toward the surrounding area of the plurality of target state candidates in preparation for change of the target state, and the local target state is set to the passage point, thus even when the target state is changed, the moving body can be operated without a sudden change of the trajectory, and can reach the changed target state.

### BRIEF DESCRIPTION OF DRAWINGS

FIG. 1 A block diagram illustrating a configuration of a moving body provided with a passage point generation apparatus according to an embodiment 1 of the present disclosure.

FIG. 2 A diagram schematically illustrating a state where the moving body enters a traveling lane of a tollgate.

FIG. 3 A flow chart illustrating an example of an operation of the passage point generation apparatus according to the embodiment 1 of the present disclosure.

FIG. 4 A conceptual diagram illustrating processing of generating a target state candidate set.

FIG. 5 A conceptual diagram for explaining a target state candidate.

FIG. 6 A conceptual diagram for explaining a reachable boundary.

FIG. 7 A block diagram illustrating a configuration of a modification example of a target state candidate generation part.

FIG. 8 A conceptual diagram for explaining processing of generating a virtual trajectory to a travelable state.

FIG. 9 A conceptual diagram for explaining processing in a modification example of the target state candidate calculation part.

FIG. 10 A conceptual diagram for explaining processing of calculating a local target state in the local target state generation part.

FIG. 11 A conceptual diagram for explaining processing of calculating the local target state in the local target state generation part.

FIG. 12 A conceptual diagram for explaining processing of calculating the local target state in the local target state generation part.

FIG. 13 A conceptual diagram in a case where the local target state is expressed by a region.

FIG. 14 A conceptual diagram in a case where the local target state is expressed by a probability distribution.

FIG. 15 A conceptual diagram for explaining processing of calculating the local target state in a case where the target state candidate is weighted.

FIG. 16 A conceptual diagram for explaining processing of calculating the local target state in a case where a virtual trajectory is weighted.

FIG. 17 A conceptual diagram for explaining processing of generating a target trajectory of a moving body in a trajectory generation part.

FIG. 18 A conceptual diagram for explaining processing of generating a target trajectory from among the target state candidates in the trajectory generation part.

FIG. 19 A conceptual diagram illustrating an example of a sudden change of the local target state.

FIG. 20 A conceptual diagram illustrating an example of a sudden change of the local target state.

FIG. 21 A conceptual diagram for explaining processing of limiting the sudden change of the local target state.

FIG. 22 A block diagram illustrating a configuration of a moving body provided with a passage point generation apparatus according to an embodiment 2 of the present disclosure.

FIG. 23 A conceptual diagram for explaining processing of generating a global target state in the global target state generation part.

FIG. 24 A conceptual diagram for explaining processing in the target state candidate calculation part.

FIG. 25 A conceptual diagram for explaining processing in a modification example of the target state candidate calculation part.

FIG. 26 A block diagram illustrating a configuration of a control server provided with a passage point generation apparatus according to an embodiment 3 of the present disclosure.

FIG. 27 A conceptual diagram illustrating a system in which a local target state is transmitted from the control server to the moving body via communication between control server and the moving body.

FIG. 28 A diagram illustrating a hardware configuration achieving the passage point generation apparatus according to the embodiments 1 to 3.

FIG. 29 A diagram illustrating a hardware configuration achieving the passage point generation apparatus according to the embodiments 1 to 3.

### DESCRIPTION OF EMBODIMENT(S)

### Embodiment 1

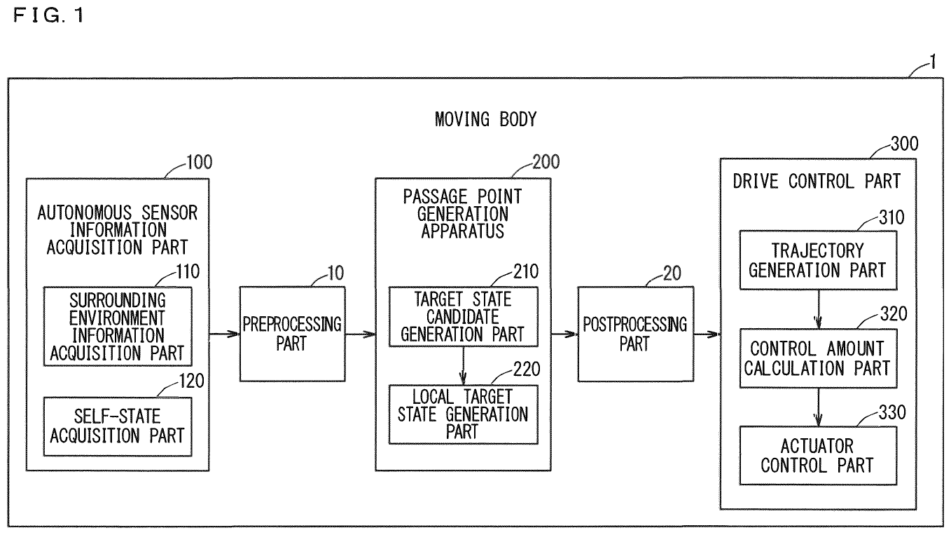

FIG. 1 is a block diagram illustrating a configuration of a moving body 1 provided with a passage point generation apparatus according to an embodiment 1 of the present disclosure.

The moving body 1 illustrated in FIG. 1 includes an autonomous sensor information acquisition part 100 acquiring surrounding environment information in which the moving body 1 should travel, a destination of the moving body 1, and a self-state of the moving body 1, a passage point generation apparatus 200 generating a passage point which the moving body 1 should reach based on information acquired from the autonomous sensor information acquisition part 100, and a drive control part 300 controlling driving of the moving body 1 so that the moving body 1 reaches a local target state based on the local target state generated by the passage point generation apparatus 200. The information acquired in the autonomous sensor information acquisition part 100 is inputted to the passage point generation apparatus 200 via a preprocessing part 10, and a function of the preprocessing part 10 is described hereinafter. The local target state generated by the passage point generation apparatus 200 is inputted to the drive control part 300 via a postprocessing part 20, and a function of the postprocessing part 20 is described hereinafter.

The autonomous sensor information acquisition part 100 includes a surrounding environment information acquisition part 110 and a self-state acquisition part 120.

The surrounding environment information acquisition part 110 acquires spatial information of a wall around the moving body, a relative position and speed of a moving obstacle such as the other moving body, an azimuth angle, and a space in which the moving body can travel without prevented by an obstacle. These pieces of information are acquired by a millimeter-wave radar, a camera, a light detection and ranging (LiDAR), and a sonar attached to the moving body, for example.

The surrounding environment information acquisition part 110 also acquires information of at least one travelable position as a travel target of the moving body 1, a travel speed, and a travel azimuth angle, for example. These piece of information are acquired from information preset by a user and a predetermined position of map information of the moving body 1, for example. Herein, the map information of the moving body 1 indicates a high-accuracy map, a car navigation map, and a point cloud map generated by a simultaneous localization and mapping (SLAM), for example.

Examples of the travelable position include a position of an entrance or a bar of each gate in a tollgate, a front wheel part of each air plane in a towing tractor, and at least one position of the moving body 1 designated by a user. Examples of the travel speed include a legal speed and a designated speed preset by a user. The travel azimuth angle is a target angle in passing through the travelable position, and examples thereof include a direction perpendicular to a gate of a tollgate in passing through the tollgate.

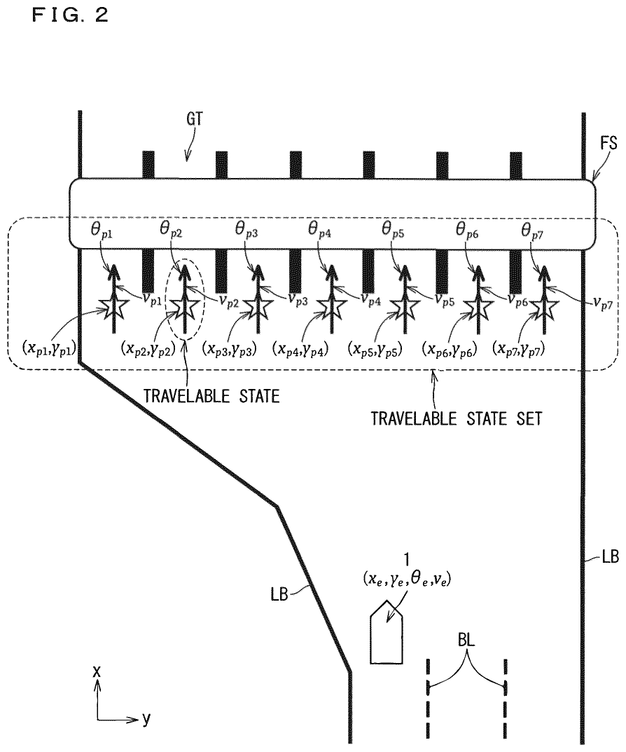

FIG. 2 is a diagram schematically illustrating a state where the moving body 1 enters a traveling lane defined by traffic lane boundaries LB on right and left sides in front of a tollgate FS. FIG. 2 illustrates an example of the travelable position, the travel speed, and the travel azimuth angle in passing through a gate GT of the tollgate. In FIG. 2, when i is a subscript, (xₚᵢ, yₚᵢ) indicates the travelable position, vₚᵢ indicates the travel speed in each travelable position, and θₚᵢ indicates the travel azimuth angle in each travelable position.

A set of the travelable positions is expressed by the following expression (1).

$$\begin{matrix}[ Expression 1 ] & \\ {P}_{p} = \{ ( {x}_{p 1} , {y}_{p 1} ) , ( {x}_{p 2} , {y}_{p 2} ) , ( {x}_{p 3} , {y}_{p 3} ) … ( {x}_{pf} , {y}_{pf} ) \} & ( 1 )\end{matrix}$$

A set of the travel speeds is expressed by the following expression (2).

$$\begin{matrix}[ Expression 2 ] & \\ {V}_{p} = \{ {v}_{p 1} , {v}_{p 2} , {v}_{p 3} … {v}_{pf} \} & ( 2 )\end{matrix}$$

A set of the travel azimuth angles is expressed by the following expression (3).

$$\begin{matrix}[ Expression 3 ] & \\ {Θ}_{p} = \{ {θ}_{p 1} , {θ}_{p 2} , {θ}_{p 3} … {θ}_{pf} \} & ( 3 )\end{matrix}$$

Herein, a subscript f is a terminal number in an environment, and the terminal number is 7 in the example in FIG. 2.

In the example in FIG. 2, when the plurality of travelable positions exist, the plurality of travel speeds and travel azimuth angles also exist, however, the number of travel speeds and travel azimuth angles may be one, thus needs not correspond to the number of the travelable positions.

A travelable state is defined by an individual travelable position, travel speed, and travel azimuth angle hereinafter, and a group of a set of the travelable positions, a set of travel speeds, and a set of the travel azimuth angles is referred to as a travelable state set.

In FIG. 2, a star mark, a direction of an arrow, and a length of the arrow schematically express the travelable position, the travel azimuth angle, and the travel speed, respectively, and the same applies to the other plan views.

The self-state acquisition part 120 includes a plurality of sensors acquiring a current state of the moving body itself. Examples of the plurality of sensors include a speed sensor, an acceleration sensor, inertial measurement apparatus, a steering angle sensor, a steering torque sensor, a yaw rate sensor, and a global navigation satellite system (GNSS) sensor. Herein, the inertial measurement apparatus is referred to as an inertial measurement unit (IMU) sensor.

In the example in FIG. 2, a state amount of the current moving body 1 is expressed as (xₑ, yₑ, θₑ, vₑ), xₑ indicates an x coordinate of the position of the moving body 1, yₑ indicates a y coordinate of the position of the moving body 1, and θₑ indicates an azimuth angle of the moving body 1, and vₑ indicates a speed of the moving body 1. The state amount of the moving body 1 is not limited to the position, the azimuth angle, and the speed, but is sufficient as long as it includes at least the state amount of the position. The state amount can also include the other state amount of the moving body 1 such as an acceleration rate, a jerk, an altitude, a yaw rate, a rotational angular rate, and a steering angle, for example.

Herein, the description is returned to the description of FIG. 1. As illustrated in FIG. 1, the passage point generation apparatus 200 includes a target state candidate generation part 210 and a local target state generation part 220.

When the moving body 1 cannot travel a target state, that is the gate, selected as an initial travel target from a set of passage states, that is to say, all of the gates GT of the tollgates in an environment where the moving body 1 is located, the target state candidate generation part 210 generates at least one travelable state acquired from the surrounding environment information acquisition part 110 and a target state newly determined based on a current state of the moving body 1 acquired from the self-state acquisition part 120 as a target state candidate for changing the target state selected by the moving body 1. Herein, the target state indicates a state of one target through which the moving body 1 desires to finally passes.

The moving body 1 can execute a change of the target state in the target state candidates, and holds a changeable target state candidate. A midway change to the passage state other than the target state candidate is limited, thus a change of the target state to an unexpected target state at a position far away from the target state, which has been initially targeted, can be prevented.

The target state is not limited to the position, the speed, and the azimuth angle of the moving body 1, but is sufficient as long as it includes at least the state amount of the position. The target state can also include the other state amount of the moving body 1 such as an acceleration rate, a jerk, an altitude, a yaw rate, a rotational angular rate, and a steering angle, for example.

The local target state generation part 220 calculates one local target state reachable in any target state candidate in an intermediate point in moving to an area around at least one target state candidate acquired from the target state candidate generation part 210.

The drive control part 300 includes a trajectory generation part 310, a control amount calculation part 320, and an actuator control part 330.

The trajectory generation part 310 generates a trajectory made up of a route and a speed at which the moving body 1 should travel to reach the local target state generated in the local target state generation part 220, and outputs the generated trajectory to the control amount calculation part 320 so that the moving body 1 is controlled along the generated trajectory. At this time, a route which does not include speed information and temporal information can also be generated as the trajectory generated in the trajectory generation part 310.

The control amount calculation part 320 calculates a target control value for the moving body 1 to travel along a target trajectory based on the trajectory generated in the trajectory generation part 310 as the target trajectory, and outputs the target control value to the actuator control part 330.

The actuator control part 330 is a controller mounted on the moving body 1, and operates an actuator so that the moving body 1 follows the target control value calculated in the control amount calculation part 320. Examples of the actuator include a steering, a drive motor, and a brake.

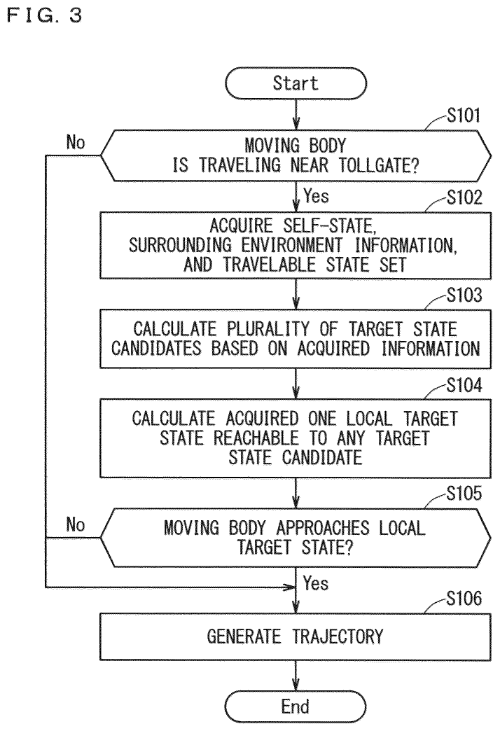

Next, an example of an operation of the passage point generation apparatus 200 is described using a flow chart illustrated in FIG. 3 with reference to FIG. 2. A case of traveling a tollgate is described hereinafter.

A region determination is performed whether a region in which the moving body 1 currently travels is located near the tollgate based on the surrounding environment information acquired in the surrounding environment information acquisition part 110 of the autonomous sensor information acquisition part 100 in the preprocessing part 10 prior to the processing in the passage point generation apparatus 200 (Step S101).

In FIG. 2, a region near the tollgate FS can be a region ranging from a position in front of a position, where a compartment line BL disappears, by an optional distance to the travelable position, that is to say, a position of passing through the gate GT of the tollgate, or can also be a region with no compartment line BL or a region within an optional distance from the travelable position.

The region determination whether the region in which the moving body 1 currently travels is located near the tollgate can be performed using positional information of a tollgate in map information of a high-accuracy map and a car navigation map of the moving body 1 or by performing image processing on an image acquired from a front camera mounted on the moving body 1.

When it is determined that the moving body 1 travels near the tollgate in Step S101 (in a case of Yes), the passage point generation apparatus 200 acquires obstacle information around the moving body and the travelable state set from the surrounding environment information acquisition part 110, and acquires a state (self-state) of the current moving body 1 from the self-state acquisition part 120 (Step S102). In the meanwhile, when the moving body 1 does not travel the tollgate (in a case of No), the passage point generation apparatus 200 generates a trajectory which the moving body 1 should travel in the trajectory generation part 310 based on information of a traffic lane of a road acquired in the surrounding environment information acquisition part 110.

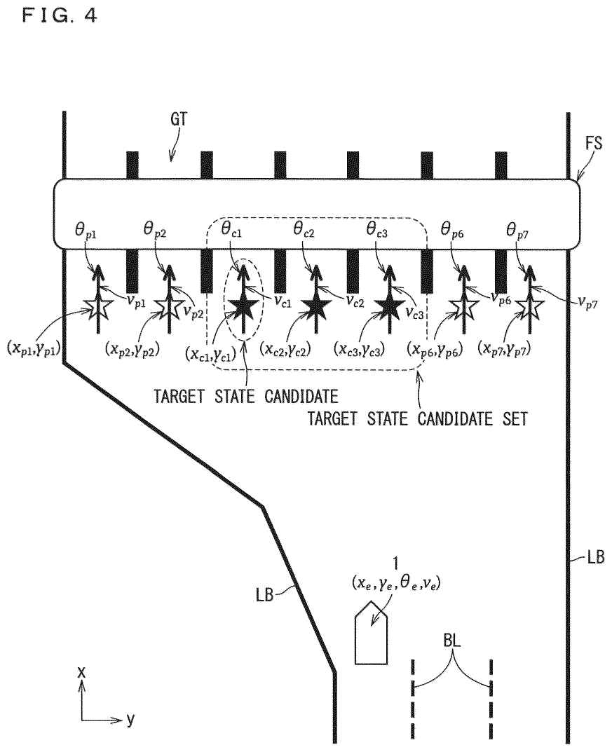

After the self-state, the surrounding environment information, and the travelable state set are acquired in Step S102, a plurality of target state candidates (target state candidate set) are generated based on the information acquired from the surrounding environment information acquisition part 110 and the self-state acquisition part 120 (Step S103). FIG. 4 illustrates a conceptual diagram of this processing.

### <Processing in Target State Candidate Generation Part>

FIG. 4 schematically illustrates a state where the moving body 1 enters a traveling lane in front of the tollgate FS, and in FIG. 4, when i is a subscript, (Xci, Yci) indicates the target position candidate, vci indicates the target speed candidate, and Oci indicates the target azimuth angle candidate.

A set of the target position candidates is expressed by the following expression (4).

$$\begin{matrix}[ Expression 4 ] & \\ {P}_{c} = [ ( {x}_{c 1} , {y}_{c 1} ) , ( {x}_{c 2} , {y}_{c 2} ) , ( {x}_{c 3} , {y}_{c 3} ) … ( {x}_{ce} , {y}_{ce} ) \} & ( 4 )\end{matrix}$$

A set of the target speed candidates is expressed by the following expression (5).

$$\begin{matrix}[ Expression 5 ] & \\ {V}_{c} = \{ {v}_{c 1} , {v}_{c 2} , {v}_{c 3} … {v}_{ce} \} & ( 5 )\end{matrix}$$

A set of the target azimuth angle candidates is expressed by the following expression (6).

$$\begin{matrix}[ Expression 6 ] & \\ {Θ}_{c} = \{ {θ}_{c 1} , {θ}_{c 2} , {θ}_{c 3} … {θ}_{ce} \} & ( 6 )\end{matrix}$$

Herein, a subscript e is a terminal number in an environment, and the terminal number is 3 in the example in FIG. 4.

In the example in FIG. 4, when the plurality of target position candidates exist, the plurality of target speed candidates and target azimuth angle candidates also exist, however, the number of the target speed candidates and target azimuth angle candidates may be one, thus needs not correspond to the number of the target position candidates.

The target state candidate is defined by the individual target position candidate, target speed candidate, and target azimuth angle candidate, and a group of a set of the target position candidates, a set of the target speed candidates, and a set of the target azimuth angle candidates is referred to as a target state candidate set.

In the example in FIG. 4, the target state candidates are three travelable states selected from the travelable state set obtained from the surrounding environment information acquisition part 110 illustrated in FIG. 2, and are indicated by star marks filled with a black color. In other words, three travelable states narrowed down from the travelable state set illustrated in FIG. 2 are the target state candidate set.

As indicated by the example in FIG. 4, the travelable states adjacent to each other are selected in each target state candidate, thus each state amount of the target state candidate set is a collection of values close to each other. This collection is a set of the state amounts in which each of the target states adjacent to each other is within a predetermined range which is previously set.

The target state candidates are located close to each other, thus a correction of the trajectory by a change of the target state can be executed more smoothly.

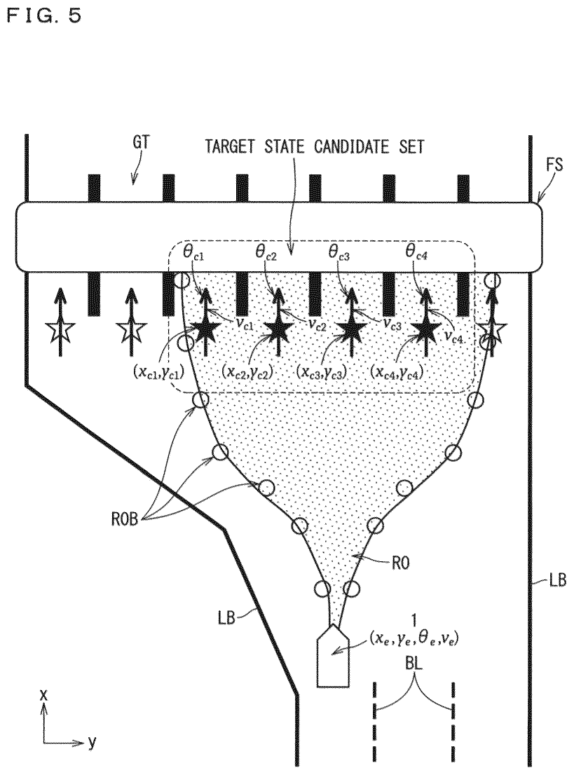

As illustrated in FIG. 5, the target state candidates are state amounts, all of which are within a reachable region R0 which the moving body 1 can kinematically reach and on which reachability is ensured.

That is to say, FIG. 5 illustrates a plurality of reachable boundaries R0B defining the reachable region R0 by circle marks, the reachable boundaries R0B in anteroposterior positions are connected to constitute a reachable boundary line, and a region between two reachable boundary lines constitutes the reachable region R0.

Reachability is ensured in any target state candidate, thus there is a high possibility that the moving body 1 reaches any of the target states.

In the example in FIG. 5, the reachable region R0 includes four target state candidates, and they constitute the target state candidate set. In the example in FIG. 5, all of four target state candidates in the reachable region R0 are selected, however, all of them need not be selected, but an optional number thereof can also be selected.

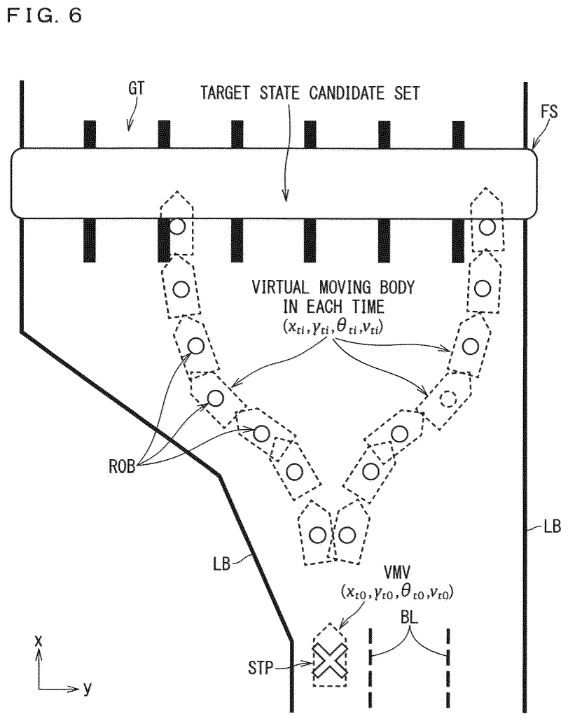

The reachable boundary R0B can be expressed by a discrete predicted trajectory obtained by repetitively inputting an optional acceleration rate, an optional maximum steering speed, that is to say, a limit value in the moving body 1 from an optional initial state such as an optional speed, an optional start position, and an optional azimuth angle, for example, to a simple dynamics model of a moving body such as the following expression (7), for example. FIG. 6 illustrates a conceptual diagram of this expression.

$$\begin{matrix}[ Expression 7 ] & \\ [ \begin{matrix}{x}_{t + 1} \\ {y}_{t + 1} \\ {θ}_{t + 1} \\ {v}_{t + 1} \\ {δ}_{t + 1}\end{matrix} ] = [ \begin{matrix}{x}_{t} \\ {y}_{t} \\ {θ}_{t} \\ {v}_{t} \\ {δ}_{t}\end{matrix} ] + [ \begin{matrix}{v}_{t} cos ( {θ}_{t} + {β}_{t} ) \\ {v}_{t} sin ( {θ}_{t} + {β}_{t} ) \\ \frac{{v}_{t} sin ( δ t )}{L} \\ {a}_{t + 1} \\ {umax}_{t + 1}\end{matrix} ] dt & ( 7 )\end{matrix}$$

In the expression (7), t indicates a time variable, dt indicates one sampling time in a control cycle, umax indicates a maximum steering angular speed input, and there are two patterns of rotational direction in a right-left direction. Moreover, a indicates an optional acceleration rate input, δ indicates a steering angle, L indicates a wheel base, and β indicates a moving body sideslip angle. Herein, the maximum steering angular speed input is defined by a maximum value of a rotational angle (deg/sec) of a steering wheel of an automobile per unit second, for example, and is set to a value in consideration of security.

In the example in FIG. 6, it is assumed that a start position is set to a position where the compartment line BL disappears and a tollgate area is started, and a virtual moving body VMV is located in the start position STP at an initial state amount (xₜ₀, yₜ₀, θₜ₀, vₜ₀). Then, optional input values are repetitively provided to the expression (7) defining an operation of the virtual moving body every hour, thus a discrete predicted trajectory of the virtual moving body VMV can be obtained for each hour as illustrated in FIG. 6. Herein, the optional input values are values different enough to obtain the predicted trajectory defining the reachable region R0.

In the present embodiment 1, a discrete predicted trajectory obtained by repetitively inputting an upper limit value of an input value, that is to say, a trajectory expressed by the plurality of virtual moving bodies VMV on a left side of FIG. 6 and a discrete predicted trajectory obtained by repetitively inputting a lower limit value of an input value, that is to say, a trajectory expressed by the plurality of virtual moving bodies VMV on a right side of the FIG. 6 are defined as a reachable boundary.

Herein, the upper limit value of the input value is a maximum steering angular speed input umax or a maximum acceleration rate input, for example, and the maximum steering angular speed input umax and an acceleration rate a set to zero as a fixed value are inputted, or a steering angular speed u set to a fixed value and an acceleration rate a set to a constant acceleration rate are inputted in some cases. The lower limit value of the input value is a minimum steering angular speed input or a minimum acceleration rate input, for example.

The upper limit value and the lower limit value of the input value are not limited to values regarding a performance limit of the moving body 1, but can be a value in consideration of ride quality or a value optionally determined by a user.

Examples of the value in consideration of the ride quality include an acceleration rate, a jerk, a rotational speed, and a rotational acceleration rate set to be smaller than a predetermined value. At least one of them can also be smaller than a predetermined value. This predetermined value can also be a preset fixed value, or can also be a value adjustable by a user.

The upper limit value and the lower limit value of the input value are set to the values in consideration of the ride quality, thus there is a high possibility that the moving body can reach any target state with high ride quality.

The dynamics model of the virtual moving body is not limited to the expression (7), however, also applicable is the other model such as a two-wheel model as a dynamics model in which four wheels are approximated to a two wheel and a dynamics model for each target moving body, for example.

The reachable boundary R0B can be set not only by the trajectory predicted by the dynamics model but also by a splined curve, a clothoid curve, a polynomial curve of degree n, or a straight line optionally set by a user, for example

The reachable region R0 is a static region calculated from a fixed start position, but can also be a dynamic region obtained by repetitively performing calculation every time the moving body is moved based on a current state of the moving body 1 moved every second as a start position.

### <Processing in Target State Candidate Generation Part According to Modification Example>

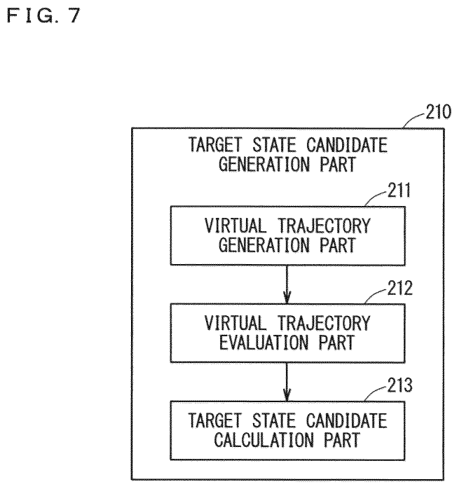

The target state candidate generation part 210 illustrated in FIG. 1 generates the target state newly determined based on at least one travelable state acquired from the surrounding environment information acquisition part 110 and the current state of the moving body 1 acquired from the self-state acquisition part 120 as the target state candidate, however, a configuration illustrated in FIG. 7 is also applicable.

Applicable is a configuration illustrated in FIG. 7 that the target state candidate generation part 210 includes a virtual trajectory generation part 211 generating a virtual trajectory which the moving body 1 travels along or reach each travelable state, a virtual trajectory evaluation part 212 evaluating the virtual trajectory based on a dynamics limitation of the moving body 1, and a target state candidate calculation part 213 selecting the travelable state which the moving body 1 can reach along a virtual trajectory within the limitation as the target state candidate. A method of generating the target state candidate by the configuration is described hereinafter.

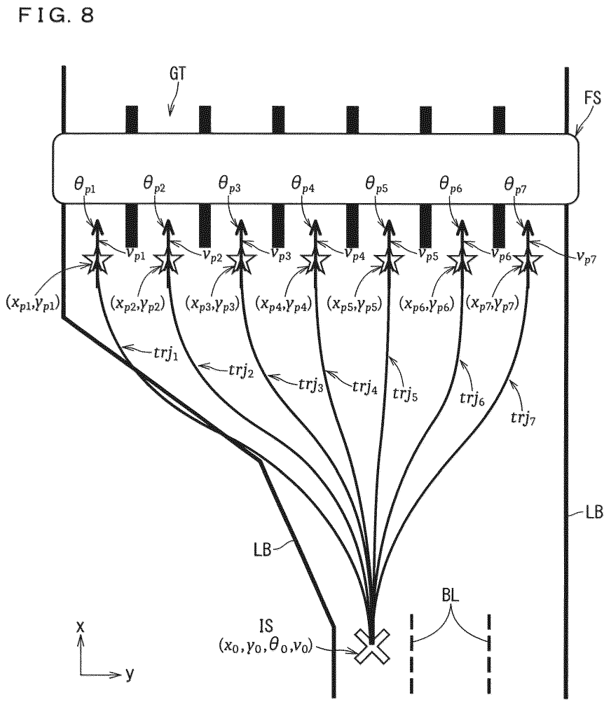

FIG. 8 is a conceptual diagram for explaining processing of generating a virtual trajectory to a travelable state in the virtual trajectory generation part 211. In FIG. 8, when i is a subscript, trjᵢ expresses a virtual trajectory to an i^{th} travelable state.

Herein, an initial state IS is a start position of a tollgate area where the compartment line BL disappears, and has a state amount (x₀, y₀, θ₀, v₀).

The virtual trajectory is expressed by a polynomial such as an expression (8), for example, and each coefficient can be derived by solving a simultaneous equation of a boundary condition in the initial state and each travelable state expressed by the following expressions (9) to (14).

$$\begin{matrix}[ Expression 8 ] & \\ {trj}_{i} = {f}_{i} ( x ) = \sum {c}_{i}^{j} {x}^{j} & ( 8 )\end{matrix}$$

In the expression (8), j indicates an order of a polynomial, c indicates a coefficient of each order, and the order is five in the present embodiment 1.

$$\begin{matrix}[ Expression 9 ] & \\ f ( {x}_{0} ) = {y}_{0} & ( 9 )\end{matrix}$$

$$\begin{matrix}[ Expression 10 ] & \\ f ( {x}_{pi} ) = {y}_{pi} & ( 10 )\end{matrix}$$

$$\begin{matrix}[ Expression 11 ] & \\ {f}^{′} ( {x}_{0} ) = {y}_{0}^{′} & ( 11 )\end{matrix}$$

$$\begin{matrix}[ Expression 12 ] & \\ {f}^{′} ( {x}_{pi} ) = {y}_{pi}^{′} & ( 12 )\end{matrix}$$

$$\begin{matrix}[ Expression 13 ] & \\ {f}^{″} ( {x}_{0} ) = {y}_{0}^{″} & ( 13 )\end{matrix}$$

$$\begin{matrix}[ Expression 14 ] & \\ {f}^{″} ( {x}_{pi} ) = {y}_{p i}^{″} & ( 14 )\end{matrix}$$

Herein, f (x) indicates a first order differential of f (x), F″ (x) indicates a second order differential of f (x), the expression (9) indicates a boundary condition regarding a position in the initial state, the expression (10) indicates a boundary condition regarding a position in each travelable state, the expression (11) indicates a boundary condition regarding an inclination in the initial state, the expression (12) indicates a boundary condition regarding an inclination in each travelable state, the expression (13) indicates a boundary condition regarding a curvature in the initial state, and the expression (14) indicates a boundary condition regarding a curvature in each travelable state.

The target state candidate is located on a virtual trajectory along which the moving body 1 can reach the target state, thus a possibility of reaching any target state increases.

In the present embodiment 1, the virtual trajectory generated in the virtual trajectory generation part 211 is generated by a two point boundary value problem of a polynomial, but can also be generated by the other method such as a potential method, model base method such as model prediction control, a sampling method such as rapidly exploring random tree (RRT), and a graph search algorithm such as A* search algorithm.

In the virtual trajectory evaluation part 212, the virtual trajectory generated in the virtual trajectory generation part 211 is dynamically evaluated. For example, performed on the virtual trajectory is evaluation of reachability that a trajectory including a position with a larger curvature than a minimum turning radius of the moving body 1 exceeds a dynamics limitation, thus is determined to be a unreachable trajectory. It can also be added to evaluation items whether a generated trajectory crosses or collides with a stationary obstacle such as an outer wall acquired by the surrounding environment information acquisition part 110.

A trajectory of the virtual moving body which the moving body 1 cannot follow and a trajectory of the virtual moving body exceeding a limitation on the dynamics of the moving body 1 such as a maximum steering angular speed or a steering angle in a case where the trajectory of the virtual moving body is predicted using the dynamics model of the moving body in the expression (7) can be evaluated as the unreachable trajectory.

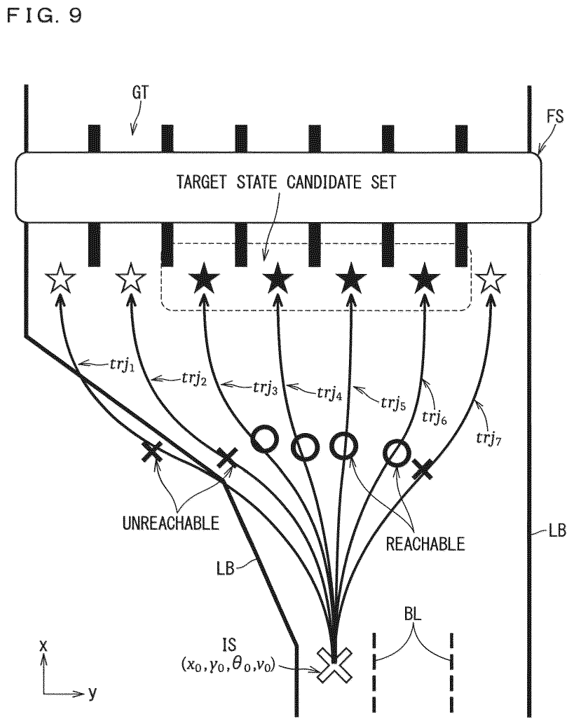

In the target state candidate calculation part 213, the travelable state reachable with the virtual trajectory evaluated as the reachable trajectory is set to the target state candidate. FIG. 9 illustrates a conceptual diagram of this processing.

FIG. 9 illustrates a trajectory evaluated as the unreachable trajectory in the virtual trajectory evaluation part 212 in virtual trajectories trj₁ to trj₇ generated in the virtual trajectory generation part 211 by cross marks, and illustrates a trajectory evaluated as the reachable trajectory by circle marks. All of the target state candidates have state amounts with which the moving body 1 can travel along a reachable virtual trajectory.

In the example in FIG. 9, there are four target state candidates, and they constitute the target state candidate set. In the example in FIG. 9, all of four target state candidates in which the moving body 1 can travel along the reachable virtual trajectory are selected, however, all of them need not be selected, but an optional number thereof can also be selected. Examples of the optional number include a maximum number or minimum number set by a user or the number of all of the reachable virtual trajectories.

Applicable as the target state candidate is a position where the moving body 1 travels along the trajectory having a score equal or larger than a predetermined threshold value or smaller than the threshold value, the score obtained by the virtual trajectory evaluation part 212 based on a predetermined evaluation index and assigned to a plurality of virtual trajectory reaching each target state candidate. Examples of this evaluation index include linearity, a length, a maximum value of curvature, or a magnitude of change ratio of curvature of a virtual trajectory or the number of turns of a steering wheel.

In the above evaluation index, assumed with regard to the linearity is a point allocation that 10 points is allocated to an almost straight trajectory and 0 point is allocated to a trajectory with no straight part, for example. A point is also allocated based on safety with regard to the length and the curvature. A sum of the points thereof is compared with a predetermined threshold value to obtain the target state candidate.

The point is allocated to the plurality of virtual trajectories reaching each target state candidate, thus the target state candidate can be changed by changing a point allocation in accordance with a preference of a designer and a user.

Example of an evaluation method in the virtual trajectory evaluation part 212 include a method of geometrically evaluating a virtual trajectory. Also considered is a method of calculating a maximum curvature Kmax of each trajectory from a virtual trajectory, and calculating a score from a value of the curvature such as 1/Kmax1, 1/Kmax2, . . . 1/Kmaxi as a score of each trajectory to evaluate the virtual trajectory, for example. Herein, a subscript i corresponds to a subscript of each trajectory.

Also considered is a method of calculating a score from a length value such as 1/L1, 1/L2, 1/L3, . . . 1/Li, in which L indicates a length of the trajectory, as a score of each trajectory to evaluate the virtual trajectory. 1/maximum curvature and 1/length are applied above by reason that a smaller value is generally preferable from a viewpoint of safety in these geometrical elements.

It is also applicable that the score corresponding to the maximum curvature and the score corresponding to the length described above are accumulated, and a total score thereof is compared with a predetermined threshold value. Weighting can also be performed when there is a geometrical element to be emphasized.

More simply, also applicable are rougher point allocation such as 7 points when a value of the maximum curvature of the trajectory is within a range of aa to bb, 6 points when the value thereof is within a range of bb to cc, and 5 points when the value thereof is within a range of cc to dd, for example. A magnitude relationship of numeral values satisfies aabb<cc<dd in the above description.

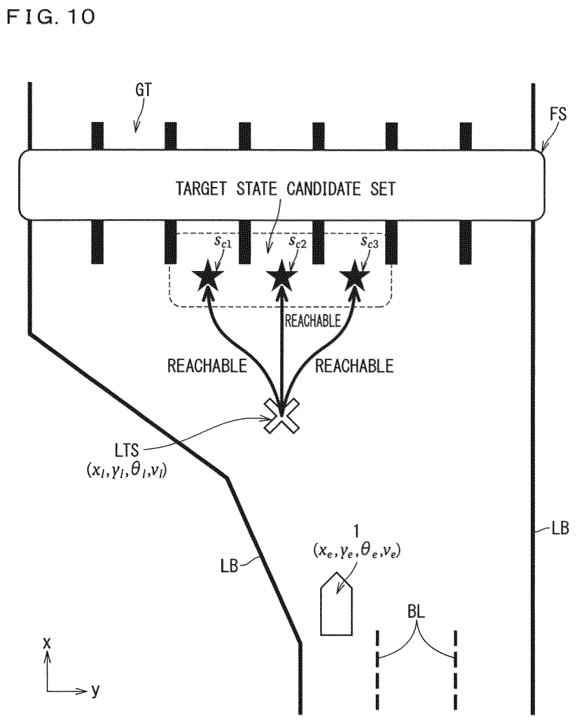

Herein, the description is returned to the description of the flow chart in FIG. 3. After the target state candidate is calculated in Step S103, calculated in the local target state generation part 220 is one local target state reachable to any target state candidate in an intermediate point in moving to an area around the target state candidate set (Step S104). This is processing based on a concept that the moving body 1 can reach any target state candidate when the moving body 1 starts traveling from the intermediate point. FIG. 10 illustrates a conceptual diagram of this processing.

### <Processing in Local Target State Generation Part>

FIG. 10 schematically illustrates a state where the moving body 1 enters a traveling lane in front of the tollgate FS, and illustrates a state where a local target state LTS is calculated in the intermediate point in moving to the area around the target state candidate set.

When i is a subscript in FIG. 10, S_{ci} expresses each target state candidate, and is defined as the following expression (15), however, a state variable can be different from a variable in the expression (15).

$$\begin{matrix}[ Expression 15 ] & \\ {s}_{ci} = [ \begin{matrix}{x}_{ci} \\ {y}_{ci} \\ {θ}_{ci} \\ {v}_{i}\end{matrix} ] & ( 15 )\end{matrix}$$

In FIG. 10, (xₗ,yₗ,θₗ,vₗ) indicates each element of the local target state LTS, and the local target state Sₗ in which each element is collected is defined as the following expression (16).

$$\begin{matrix}[ Expression 16 ] & \\ {s}_{l} = [ \begin{matrix}{x}_{l} \\ {y}_{l} \\ {θ}_{l} \\ {v}_{l}\end{matrix} ] & ( 16 )\end{matrix}$$

In the example in FIG. 10, there are three target state candidates, and they constitute the target state candidate set. The moving body 1 starts traveling from the local target state LTS, thus can reach any target state candidate.

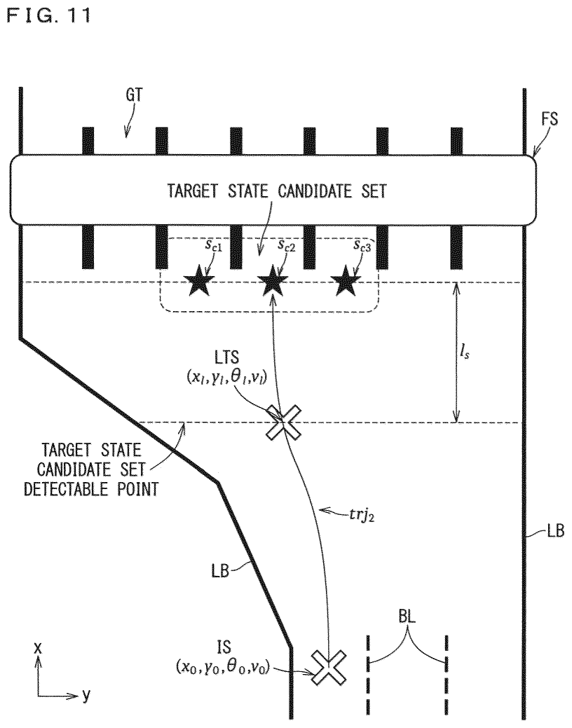

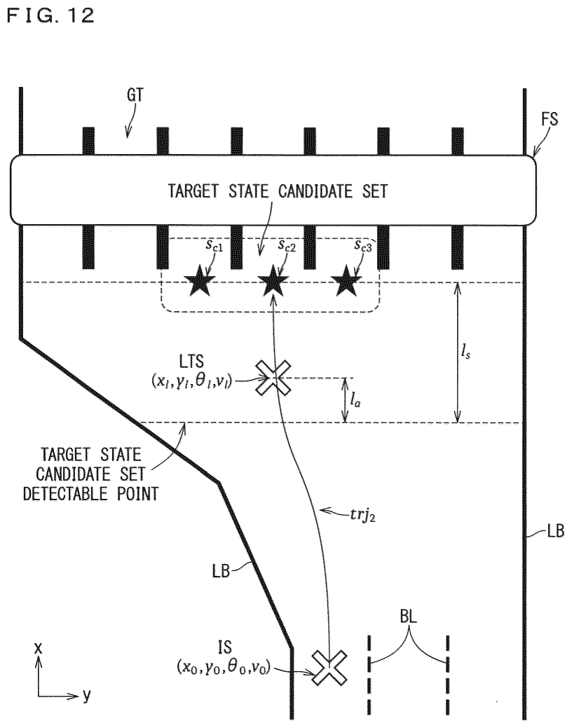

In the example in FIG. 10. the local target state LTS is a position where the moving body 1 can reach any target state candidate, however, as illustrated in FIG. 11, the local target state LTS can also be an optional position on a virtual trajectory reachable to the target state candidate in a center of the target state candidate set.

In FIG. 11, the start position of the tollgate area where the compartment line BL disappears is the initial state IS, and has the state amount (x₀, y₀, θ₀, v₀). In FIG. 11, trj₂ indicates a virtual trajectory to a second target state candidate, and Is indicates a distance detectable by an autonomous sensor. As illustrated in FIG. 11, the optional position on the virtual trajectory can be a position in front of the target state candidate set by the distance lₛ, a segment, including the position, parallel to a y direction can be a target state candidate set detectable point, and a position where the point and the virtual trajectory trj₂ intersect with each other can be the local target state LTS.

The optional position on the virtual trajectory can be a position closer to the target state candidate set than the position in front of the target state candidate set by the distance lₛ, and can be a position in front of the target state candidate set by a distance obtained by subtracting an optional distance lₐ from the distance Is as illustrated in Fi. 12, for example.

In FIG. 11, the local target state LTS is located to proceed to the target state candidate located in a center of the target state candidate set by reason that the target state candidates are located on both sides when the trajectory is corrected to change the target state candidate to the other target state candidate in a case where the moving body 1 cannot travel the target state candidate in the center, thus the number of the target state candidates for correcting the trajectory can be increased.

The local target state is located in the position in front of the target state candidate set by the distance lₛ detectable by the autonomous sensor, thus dynamic information such as a dynamic obstacle or a color of a signal of an ETC gate can be obtained in real time. When these types of dynamic information can be detected, there is a high possibility that the selected target state is changed. Thus, there is an increasing opportunity of being forced to change the target state such as a change of a gate upon approaching a target gate and detecting a broken vehicle, for example.

In the meanwhile, in the case in FIG. 11, the distance Is detectable by the autonomous sensor is smaller than a case of calculating the local target state LTS in the intermediate point in moving to the area around the target state candidate set as with the example in FIG. 10, thus the local target state LTS can be located closer to the target state candidate set, and a state where the moving body 1 cannot travel a final target state can be prevented after the moving body 1 reaches the local target state LTS.

The local target state LTS is located to proceed to the target state candidate located in the center of the target state candidate set, thus the target state candidates are located on both sides when the trajectory is corrected to change the target state candidate to the other target state candidate in the case where the moving body 1 cannot travel the target state candidate in the center, and the trajectory can be easily corrected.

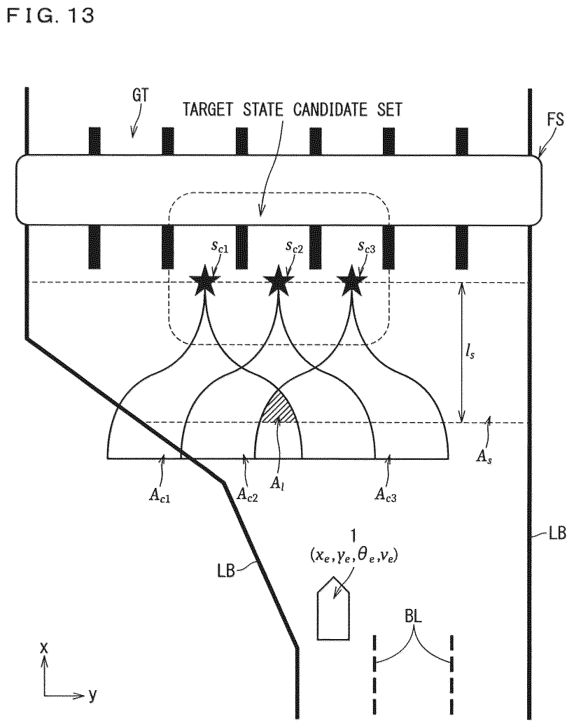

FIG. 10 and FIG. 11 illustrate the local target gate LTS at one point, however, as illustrated in FIG. 13, the local target state can also be a region.

FIG. 13 schematically illustrates a state where the moving body 1 enters a traveling lane in front of the tollgate FS, and lₛ is the distance detectable by the autonomous sensor. When i is a subscript in FIG. 13, A_{ci} is a reachable region reachable to each target state candidate S_{ci}, As is a sensor detectable region where the target state candidate set can be detected by the autonomous sensor, and Aₗ is a local target region. The local target region Aₗ is defined as a region where the reachable region A_{ci} and the sensor detectable region Aₛ of the target state candidate are overlapped with each other.

A reachable boundary constituting the reachable region A_{ci} can be expressed by a discrete predicated trajectory of a virtual moving body obtained by repetitively inputting an optional acceleration rate and an optional maximum steering speed, that is to say, a limit value in the moving body 1 to a simple dynamics model of a moving body such as the expression (7) based on an assumption that the virtual moving body proceeds in a direction opposite to an orientation in which the moving body 1 passes when the initial position is each target state candidate, for example. This is boundaries on right and left sides defining each reachable region in FIG. 13.

No matter where the moving body 1 starts traveling from, the moving body 1 can reach the target state candidate as a target in each reachable region, and furthermore, no matter where the moving body 1 starts traveling from, the moving body 1 can reach either target state candidate in the target state candidate set in the local target region Aₗ.

The dynamics model of the virtual moving body is not limited to the expression (7), however, also applicable is the other model such as a two-wheel model as a dynamics model in which four wheels are approximated to a two wheel and a dynamics model for each target moving body, for example.

The reachable boundary can be set not only by the trajectory predicted by the dynamics model but also by a splined curve, a clothoid curve, a polynomial curve of degree n, or a straight line optionally set by a user, for example.

The upper limit value and the lower limit value of the input value inputted to the dynamics model to obtain the reachable boundary are not limited to values regarding a performance limit of the moving body 1, but can be a value in consideration of ride quality or a value optionally determined by a user.

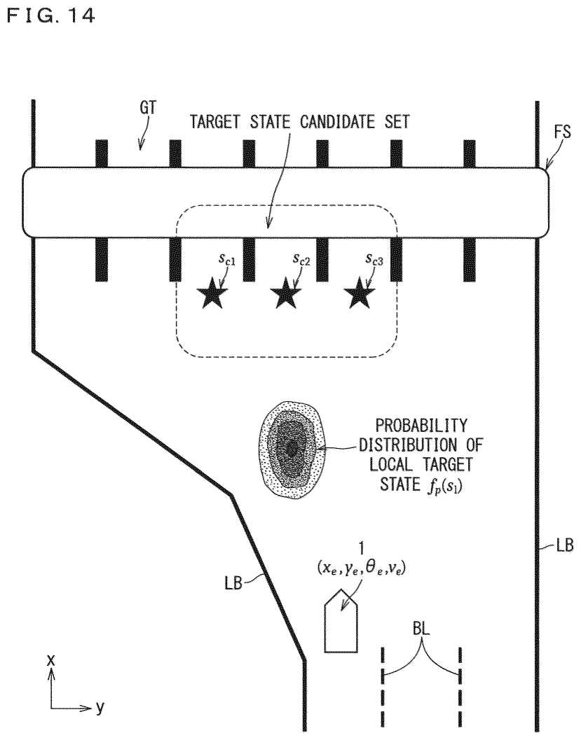

FIG. 10 and FIG. 11 illustrate the local target gate LTS at one point, and FIG. 13 illustrates the local target region, however, as illustrated in FIG. 14, the local target state can also be expressed by a probability distribution of a probability with which the moving body 1 can reach each target state candidate.

FIG. 14 schematically illustrates a state where the moving body 1 enters a traveling lane in front of the tollgate FS. A probability distribution fₚ(sᵢ) of the local target state expresses a degree of probability by a contrasting density of hatching. A region with a darkest color has a highest possibility of reaching the target state candidate, and when the moving body 1 starts traveling from this region, there is a highest possibility of reaching either target state candidate.

### <Weighting to Target State Candidate>

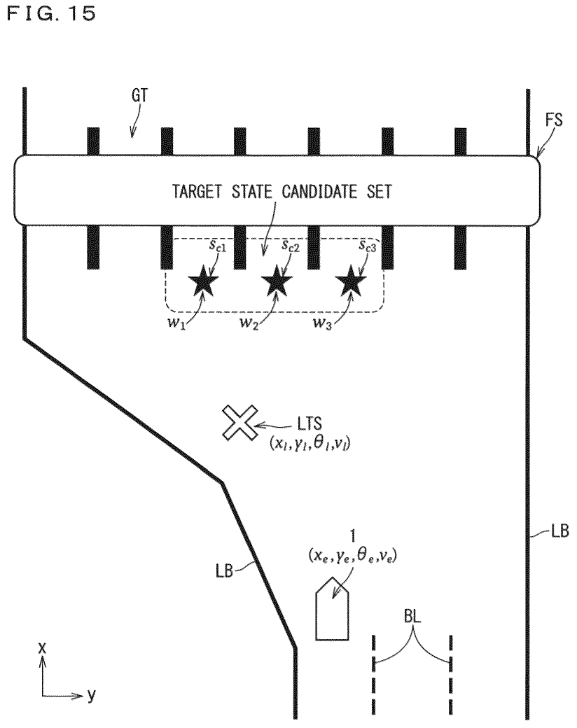

The local target state generation part 220 performs weighting based on a predetermined evaluation index for each target state candidate calculated in the target state candidate generation part 210, and can calculate the local target state based on the weight. FIG. 15 illustrates a conceptual diagram of this processing.

FIG. 15 schematically illustrates a state where the moving body 1 enters a traveling lane in front of the tollgate FS, and when i is a subscript, wᵢ is a weight assigned to the target state candidate, and w₁ is heaviest and w₃ is lightest, thus w₁>w₂>w₃ is satisfied.

The weight assigned to the target state candidate S_{c1} is heaviest, thus the local target state LTS has a state amount close to the target state candidate S_{c1}, that is to say, the local target state LTS is located closer to the target state candidate S_{c1}, and when the moving body 1 starts traveling from the local target state LTS, there is a highest possibility of reaching the target state candidate S_{c1}.

Accordingly, the local target state can be set by changing the weight in accordance with a preference of a designer and a user.

Herein, a predetermined evaluation index for each target state candidate as an index of weighting can be evaluated based on a geometrical condition such as a condition that a candidate having a shorter distance from the current moving body 1 has a larger weight, a candidate passing through a gate with a larger lateral width has a larger weight, and a candidate passing through a gate having a curved route has a lighter weight, for example.

The evaluation can be performed based on a congestion degree of a gate where the target state candidate passes or whether a gate where the target state candidate passes is an ETC gate or a general gate where the moving body 1 needs to temporarily stops, or which side a gate where the target state candidate passes is located, a right side or a left side.

The evaluation can be performed based on a complexity of a shape of a road in front of a gate where the target state candidate passes or a difficulty level of a passage of a gate such as a speed necessary to pass the gate.

### <Weighting on Virtual Trajectory>

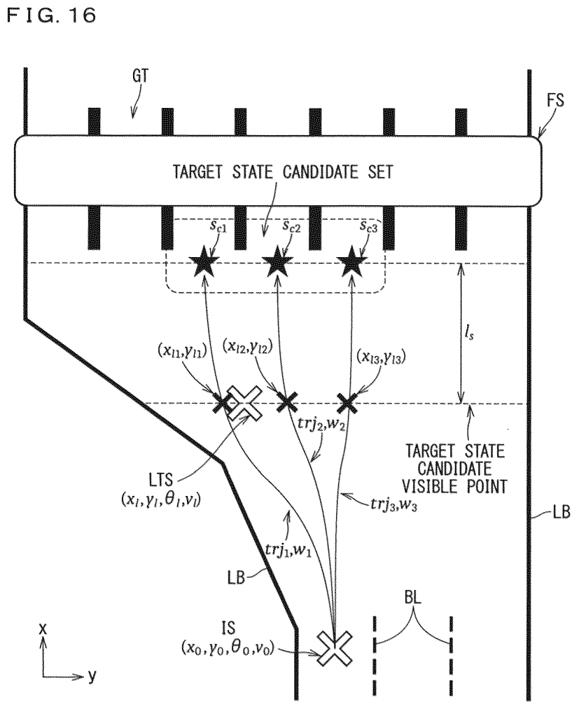

The local target state generation part 220 can perform weighting on a trajectory reaching each target state candidate in a virtual trajectory generated in the virtual trajectory generation part 211 in the target state candidate generation part 210 illustrated in FIG. 7, and set the local target state using the weight of the virtual trajectory. FIG. 16 illustrates a conceptual diagram of this processing.

FIG. 16 schematically illustrates a virtual trajectory starting from the initial state IS which is a start position of a tollgate area where the compartment line BL disappears, and lₛ is a distance detectable by the autonomous sensor. In FIG. 16, (xₗ,yₗ,θₗ,vₗ) indicates each element of the local target state LTS, and when i is a subscript, trjᵢ indicates a virtual trajectory to an i^{th} target state candidate, wᵢ is a weight assigned to the virtual trajectory trjᵢ, and (xₗᵢ,yₗᵢ) is a position where the virtual trajectory and the target state candidate set detectable point intersect with each other. This is referred to as an optional point on a virtual trajectory.

With regard to a weight assigned to the virtual trajectory trjᵢ, w₁ is heaviest and w₃ is lightest, and w₁>w₂>w₃ is satisfied. The weight assigned to virtual trajectory trj₁ is heaviest, thus the local target state LTS has a state amount close to the target state candidate S_{c1}, that is to say, the local target state LTS is located closer to the target state candidate S_{c1}, and when the moving body 1 starts traveling from the local target state LTS, there is a highest possibility of reaching the target state candidate S_{c1}.

In this manner, the local target state can be set by changing the weight in accordance with a preference of a designer and a user.

The local target state LTS obtains a weighted average of the optional point on the virtual trajectory and the weight using expressions (17) and (18), for example, thereby being able to reflect a magnitude of the weight of each virtual trajectory. The weight has a value of 1 to 0, and a subscript b on a terminal end is 3 in an example in FIG. 16.

A position x₁ of the local target state LTS in an x direction can be obtained by the following expression (17).

$$\begin{matrix}[ Expression 17 ] & \\ {x}_{l} = \frac{1}{b} {\sum }_{i = 1}^{b} {w}_{i} \cdot {x}_{li} & ( 17 )\end{matrix}$$

A position y₁ of the local target state LTS in a y direction can be obtained by the following expression (18).

$$\begin{matrix}[ Expression 18 ] & \\ {y}_{l} = \frac{1}{b} {\sum }_{i = 1}^{b} {w}_{i} \cdot {y}_{li} & ( 18 )\end{matrix}$$

The weight is set based on a distance to the moving body 1, a lateral moving amount necessary to move to each target state candidate, a congestion degree of a gate where each target state candidate passes, a selection rate of the target state selected by the other moving body, and a distance and a positional relationship with a more global target state (described in an embodiment 2), for example. As illustrated in the expressions (17) and (18), the weight in the x direction and the weight in the y direction are the same wᵢ, but may also be different from each other.

Herein, the description is returned to the description of the flow chart in FIG. 3. It is determined whether the moving body approaches the local target state in the postprocessing part 20 after the local target state is calculated in Step S104 (Step S105). For example, when Euclidean distance from the moving body 1 to the local target state is smaller than a threshold value, or when the moving body 1 reaches a local target region Aₗ described using FIG. 13, it is determined that the moving body 1 approaches the local target state.

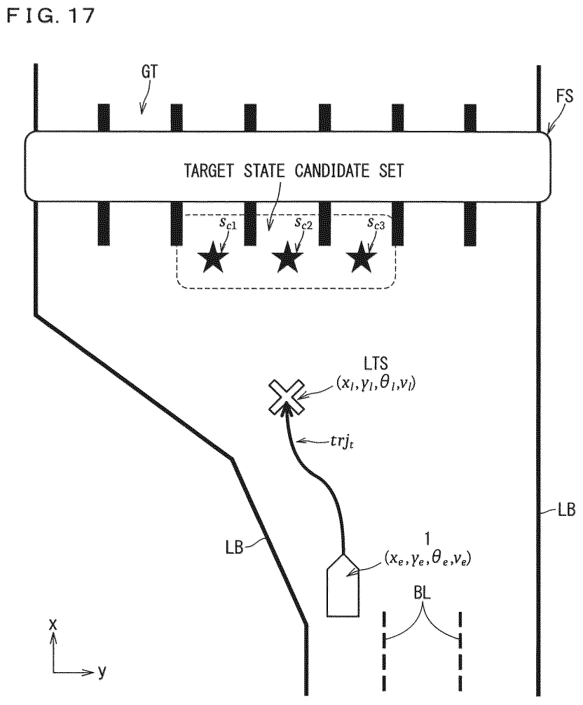

When it is determined that the moving body 1 does not approach the local target state in Step S105 (in a case of No), the process proceeds to Step S106, and the target trajectory of the moving body 1 is generated in the trajectory generation part 310 (FIG. 1) using the local target state as a target value. FIG. 17 illustrates a conceptual diagram of this processing.

FIG. 17 schematically illustrates a state where the moving body 1 enters a traveling lane in front of the tollgate FS, and illustrates a target trajectory trjₜ, generated in the trajectory generation part 310, of the moving body 1 from the position of the moving body 1 to the local target state LTS.

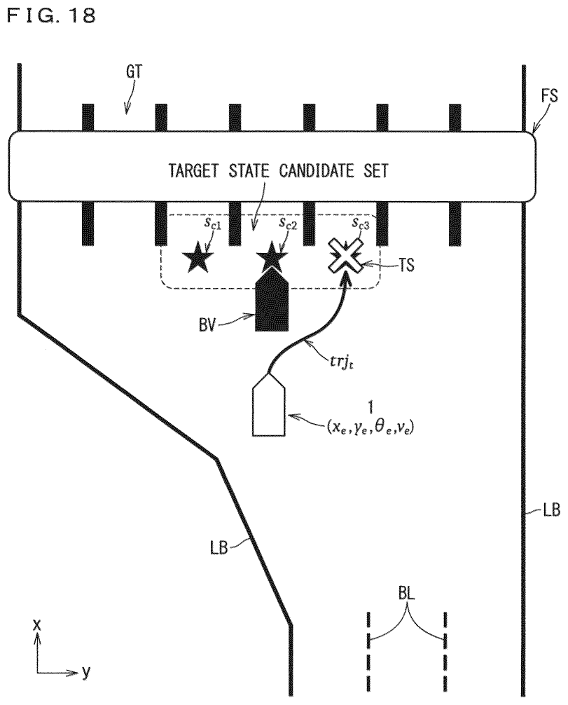

In the meanwhile, when it is determined that the moving body approaches the local target state in Step S105 (in a case of Yes), the process proceeds to Step S106, and a trajectory to one target state is generated from the target state candidate as a target trajectory in the trajectory generation part 310. FIG. 18 illustrates a conceptual diagram of this processing.

FIG. 18 illustrates a state where one target state is selected from three target state candidates after the moving body 1 approaches an initial target state candidate, and the target trajectory trjₜ to the selected target state is generated in the trajectory generation part 310.

In this case, examples of a method of selecting one target state include a method of performing weighting on the target state candidate in accordance with a predetermined index, and selecting the target state candidate having a large weight.

Herein, examples of the predetermined index include a distance to the moving body 1, a lateral moving amount necessary to move to each target state candidate, a congestion degree of a gate where each target state candidate passes, a selection rate of the target state selected by the other moving body, and a distance and a positional relationship with a more global target state (described in an embodiment 2).

When there is a broken vehicle BV near one target state candidate as illustrated in FIG. 18 or when there is a target state candidate where a signal light of the gate GT of the tollgate turns red and the moving body 1 cannot pass, applicable is a method of eliminating the corresponding target state candidate.

In this manner, a trajectory generated in subsequent Step S106 varies depending on whether a determination result in Step S105 is Yes or No. That is to say, when the determination in Step S105 is Yes, the trajectory generation part 310 generates a trajectory to the target state, and when the determination in Step S105 is No, the trajectory generation part 310 generates a trajectory to the local target state. The sequential processing is finished after any trajectory is generated in Step S106. The control amount calculation part 320 in the drive control part 300 calculates a target control value for the moving body 1 to travel along the target trajectory based on the generated trajectory, and the actuator control part 330 operates an actuator so that the moving body 1 follows the target control value, however, a known technique can be applied for these operations, thus the description is omitted.

Herein, in the case where the trajectory to the local target state is generated in the trajectory generation part 310, when the local target state is suddenly changed after the moving body 1 approaches the local target state to some extent, a sudden correction of the trajectory is necessary in the moving body 1, and no trajectory reachable to the local target state after change may be found in some cases, thus such a sudden change of the local target state can be limited. Specifically, a change of a target state amount in which a change of a state amount per unit time is equal to or larger than a predetermined amount can be limited.

The change of the sudden local target state is limited, thus the sudden correction of the trajectory of the moving body 1 can be prevented, and also preventable is a state where no trajectory reachable to the local target state after change is found.

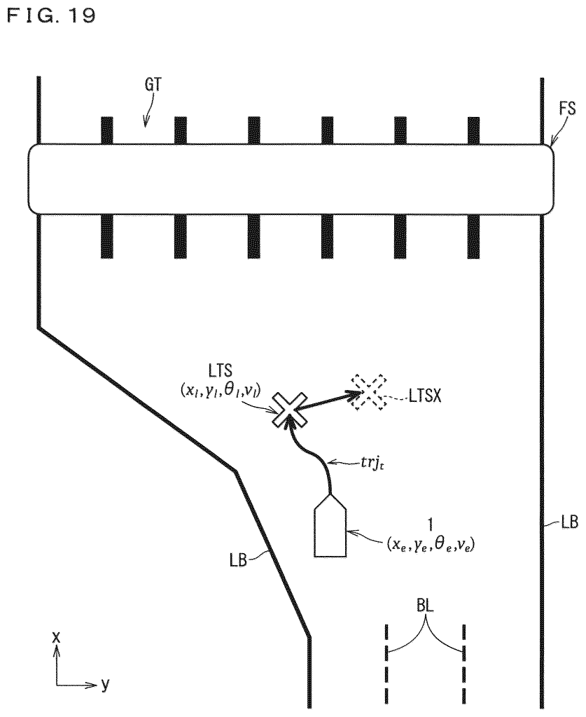

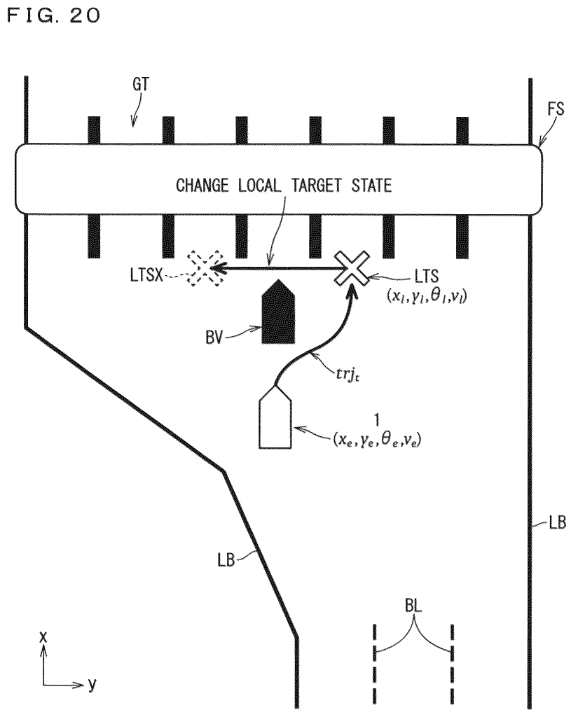

FIG. 19 and FIG. 20 illustrate an example of such a sudden change of the local target state. FIG. 19 illustrates the target trajectory trjₜ of the moving body 1 from the current position of the moving body 1 to the initial local target state LTS. When the local target state is suddenly changed to a local target state LTSX, the moving body 1 cannot reach the local target state LTSX after change by the initial target trajectory trjₜ. In such a case, a new target trajectory trjₜ is generated, and it takes time for generation.

FIG. 20 illustrates a case where the initial local target state LTS is located near the tollgate FS. When the local target state is suddenly changed to the local target state LTSX, no trajectory reachable to the local target state LTSX after change may be found or there is no time for calculation in some cases by reason that the broken vehicle BV is located in front of the gate GT of the tollgate.

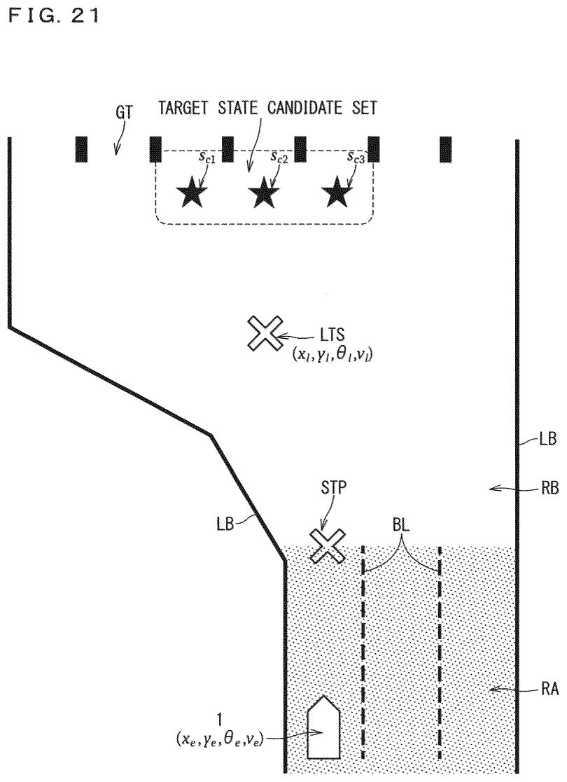

Furthermore, a period for the processes in Step S101 to Step S104 in FIG. 3 can also be limited. This limitation is described using FIG. 21.

FIG. 21 illustrates a start point STP as the start position of the tollgate area where the compartment line BL disappears, a region RA on a near side of the start position STP, and a region RB closer to a side of the gate GT of the tollgate in relation to the start position STP. The processes in Step S101 to Step S104 in FIG. 3 are performed when the moving body 1 travels the region RA. The processes in Step S101 to Step S104 are not performed after the moving body 1 passes through the start position STP, however, values of the target state candidate set and the local target state LTS calculated when the moving body 1 travels the region RA are used.

Prevented accordingly are a continuous change of the local target state as a target for the moving body 1 after passing through the start point STP and variation of the target value of the moving body 1, and fluctuation of the generated trajectory, that is to say, fluctuation of the target value in generating the trajectory can be prevented.

The start position STP is not limited to the position where the compartment line BL disappears, but may also be a position in front of the position where the compartment line BL disappears by a predetermined distance.

As described above, according to the passage point generation apparatus 200 of the embodiment 1, the candidates of the plurality of target passage points are determined in consideration of the correction of the target passage point in the initial stage of determining the target passage point. The local target state LTS reachable to any target passage point is set in the intermediate point, and the moving body 1 travels toward the intermediate point. Thus, even when the target passage point is changed during or before traveling near the intermediate point, it is possible to flexibly deal with the change of the target passage point, and a passage probability of the target passage point can be increased. When the moving body 1 cannot travel the target passage point, the operation of changing the target passage point to the other passage point can be performed without sudden processing of correcting the trajectory.

### Embodiment 2

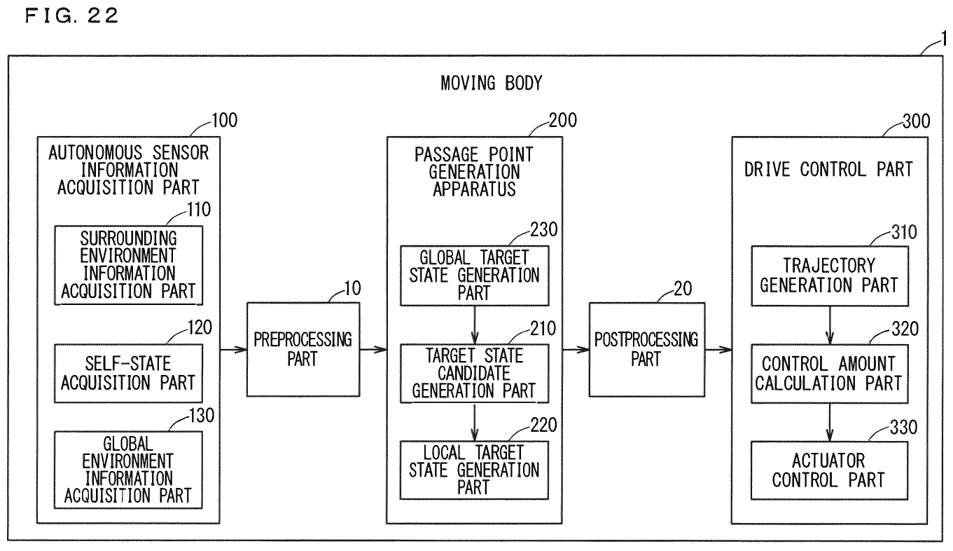

FIG. 22 is a block diagram illustrating a configuration of the moving body 1 provided with a passage point generation apparatus according to an embodiment 2 of the present disclosure. In FIG. 22, the same reference numerals are assigned to the same constituent elements as the moving body 1 described using FIG. 1, and the repetitive description is omitted.

The moving body 1 illustrated in FIG. 22 includes the surrounding environment information acquisition part 110, the self-state acquisition part 120, and a global environment information acquisition part 130 in the autonomous sensor information acquisition part 100.

The global environment information acquisition part 130 acquires global information with a larger range than the surrounding environment information acquisition part 110. For example, route information of a traffic lane and information of a more global destination, passage position, and relay point fall under this global information. These pieces of information are acquired from information previously designated by a user, predetermined route information and positional information in map information of the moving body 1, a high-accuracy locator, and an in-vehicle communication apparatus, for example.

The moving body 1 includes a global target state generation part 230, the target state candidate generation part 210, and the local target state generation part 220 in the passage point generation apparatus 200.

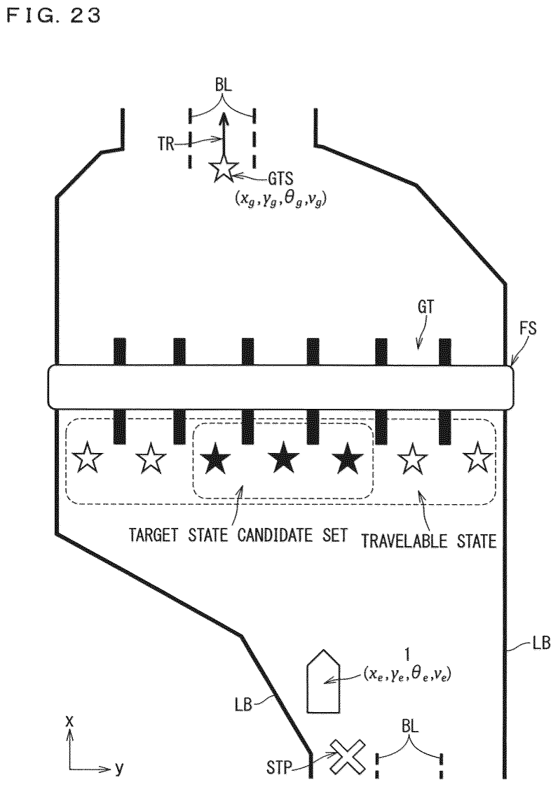

The global target state generation part 230 generates a global target state as a more global target state than the travelable state acquired in the surrounding environment information acquisition part 110 and the target state candidate set generated in the target state candidate generation part 210 based on information of a global destination, for example, acquired from the global environment information acquisition part 130. FIG. 23 illustrates a conceptual diagram of this processing.

FIG. 23 illustrates a state where the moving body 1 passes through the start position STP and is approaching the tollgate FS, and a global target state GTS is located on a far side of the tollgate FS.

In FIG. 23, (x_{g},y_{g},θ_{g},v_{g}) indicates each element of the global target state GTS, (x_{g},x_{g}) indicates a global target position, v_{g} indicates a global target speed, and θ_{g} indicates a global target azimuth angle. Herein, it is sufficient that the global target state includes at least information of a position, thus it is also applicable that the global target state does not include information of a speed and an azimuth angle. A target route TR in FIG. 23 is an example of information acquired in the global environment information acquisition part 130, and the global target state GTS in FIG. 23 indicates an initial position of the moving body 1 necessary to travel in accordance with the target route TR.

In the example in FIG. 23, the target state candidates are three travelable states selected from the travelable state set, and are indicated by star marks filled with a black color as the target state candidate set.

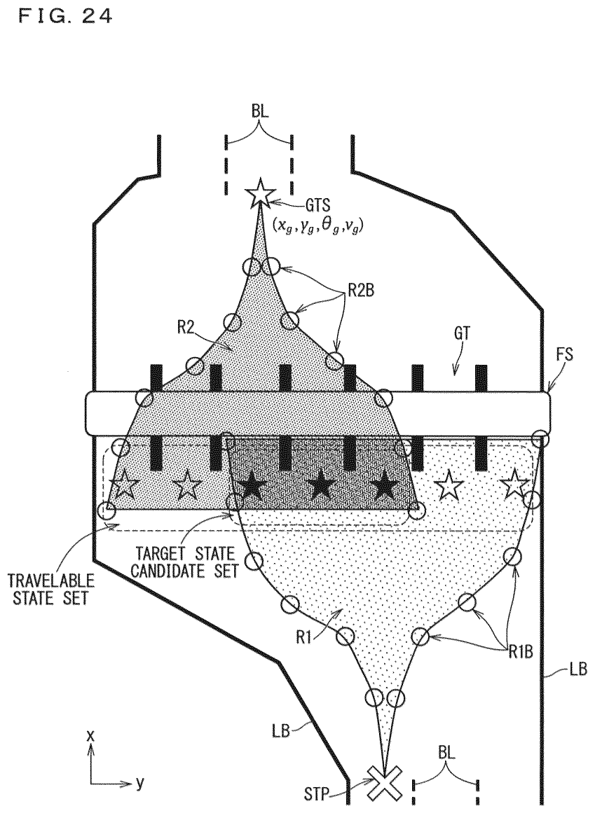

The target state candidate generation part 210 generates the target state candidate from the travelable state set in a region where the reachable region which the moving body 1 can kinematically reach from the start position STP as the initial position and the reachable region which the moving body 1 can kinematically reach the global target state GTS are overlapped with each other. FIG. 24 illustrates a conceptual diagram of this processing.

In FIG. 24, a reachable region R1 is a region which the moving body can kinematically reach from the start position STP, a plurality of reachable boundaries R1B are indicated by circle marks, the sequential reachable boundaries RIB are connected to constitute a reachable boundary line, and a region sandwiched between two reachable boundary lines is the reachable region R1.

A reachable region R2 is a region which the moving body can kinematically reach the global target state GTS, a plurality of reachable boundaries R2B are indicated by circle marks, the sequential reachable boundaries R2B are connected to constitute a reachable boundary line, and a region sandwiched between two reachable boundary lines is the reachable region R2. The target state candidate is a state amount in a region where the reachable region R1 and the reachable region R2 are overlapped with each other.

The reachable regions R1 and R2 can be obtained by deriving the reachable boundaries RIB and R2B by a discrete predicted trajectory of a virtual moving body obtained using a simple dynamics model of a moving body as with the expression (7) described in the embodiment 1.

### <Processing in Target State Candidate Generation Part According to Modification Example>

In place of the target state candidate generation part 210 illustrated in FIG. 22, applicable is the configuration illustrated in FIG. 7 that the target state candidate generation part 210 includes the virtual trajectory generation part 211 generating the virtual trajectory, the virtual trajectory evaluation part 212 evaluating the virtual trajectory based on the dynamics limitation of the moving body 1, and the target state candidate calculation part 213 selecting the travelable state which the moving body 1 can reach along the virtual trajectory within the limitation as the target state candidate.

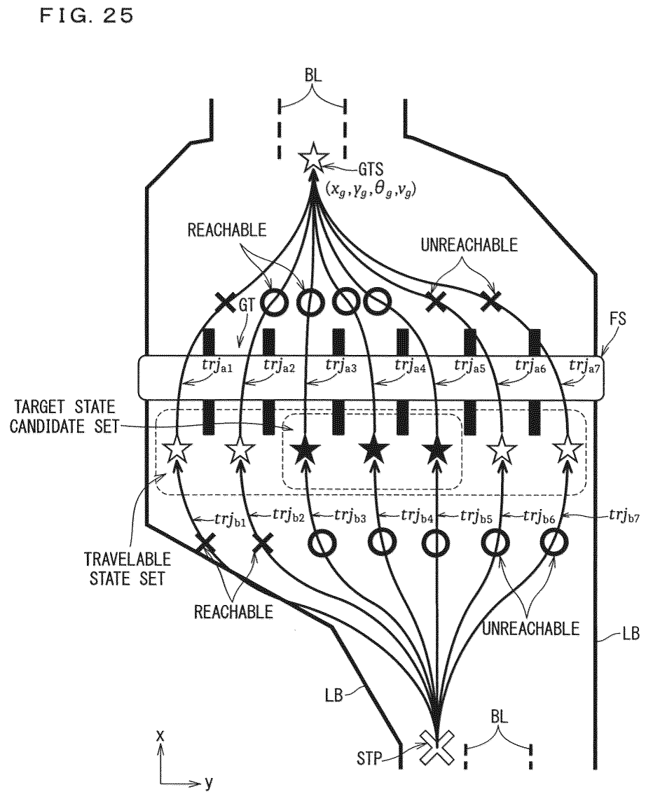

FIG. 25 is a conceptual diagram for explaining processing of generating the virtual trajectory to the travelable state in the virtual trajectory generation part 211. In FIG. 25, when i is a subscript, trj_{bi} indicates a virtual trajectory to the travelable state, and trjₐᵢ indicates a virtual trajectory from an i^{th} travelable state to the global target state GTS.

Firstly, the virtual trajectory generation part 211 generates each of a virtual trajectory from the start position STP to the travelable state and a virtual trajectory from the travelable state to the global target state GTS, and next, the virtual trajectory evaluation part 212 dynamically evaluates the virtual trajectory. Finally, a passage state which the moving body 1 can pass in combination of two reachable trajectories made up of the virtual trajectory from the start STP to the travelable state and the virtual trajectory from the travelable state to the global target state both evaluated to be reachable is set to the target state candidate.

The virtual trajectory is expressed by a polynomial as with the expression (8) described in the embodiment 1, and can be obtained by solving a simultaneous equation under a boundary condition expressed by the expressions (9) to (14) and deriving each coefficient.

In the virtual trajectory evaluation part 212, the target state candidate provides scores to a plurality of virtual trajectories reaching each target state candidate from the start position STP and a plurality of virtual trajectories reaching the global target state GTS from each target state candidate based on a predetermined evaluation index. Then, set to the target state candidate is the target state which the moving body 1 can travel in combination of virtual trajectories both having scores equal to or larger than a threshold value in the virtual trajectory reaching each target state candidate and the virtual trajectory reaching the global target state GTS from each target state candidate. The weight described in the embodiment 1 may be assigned in place of providing the scores to the virtual trajectories. In this case, the weight is assigned to the plurality of virtual trajectories reaching each target state candidate from the start position STP and the plurality of virtual trajectories reaching the global target state GTS from each target state candidate.

As described above, according to the passage point generation apparatus 200 in the embodiment 2, achievable are increase of a travel probability to the target state, and the operation of changing the target state without the sudden correction of the trajectory by reason that the moving body 1 cannot travel the target state. Furthermore, when the moving body 1 further proceeds to a global target point farther away from the target state after reaching the target state, the moving body 1 can easily reach the global target point by reason that the target state takes into consideration the global target state.

### Embodiment 3

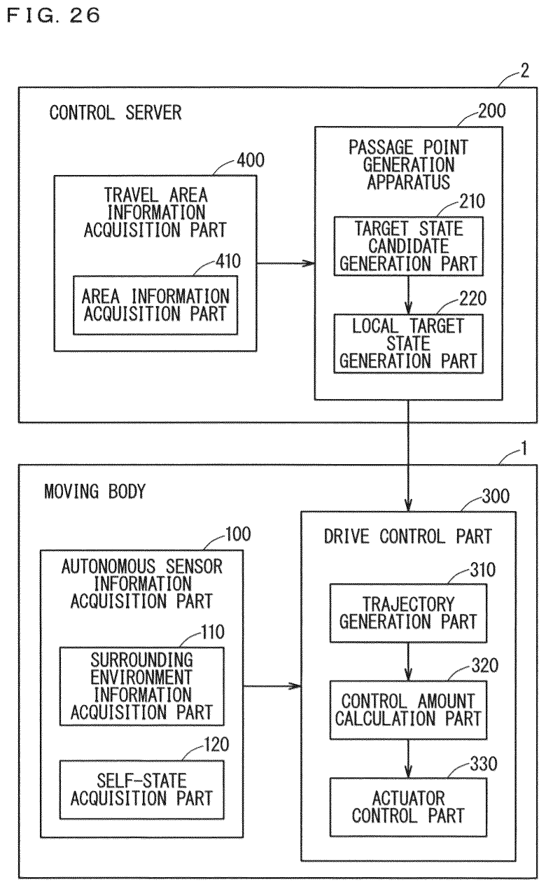

FIG. 26 is a block diagram illustrating a configuration of a control server 2 (control apparatus) provided with a passage point generation apparatus according to an embodiment 3 of the present disclosure and the moving body 1. In FIG. 26, the same reference numerals are assigned to the same constituent elements as the moving body 1 described using FIG. 1, and the repetitive description is omitted.

The control server 2 illustrated in FIG. 26 includes a travel area information acquisition part 400 and the passage point generation apparatus 200.

The travel area information acquisition part 400 includes an area information acquisition part 410. The area information acquisition part 410 acquires spatial information travelable in the tollgate area such as positional information of an outer wall defining the tollgate area, an objective state amount of the moving body 1, that is to say, a state amount not of a subject vehicle coordinate system but of an absolute coordinate system, an objective state amount of a moving obstacle, and at least one piece of information such as the travelable position, the travel speed, and the travel azimuth angle as the travel target of the moving body 1, for example. These pieces of information are collected from a roadside sensor disposed in the travel area.

The passage point generation apparatus 200 includes the target state candidate generation part 210 and the local target state generation part 220.

The target state candidate generation part 210 generates the target state which is newly determined as the target state candidate for changing the target state based on the objective state amount of the moving body 1 acquired in the area information acquisition part 410 and at least piece of information such as the travelable position, the travel speed, and the travel azimuth angle as the travel target of the moving body 1.

The local target state generation part 220 calculates one local target state reachable in any target state candidate in the intermediate point in moving to the area around at least one target state candidate acquired from the target state candidate generation part 210.

The state amount of the local target state calculated in the local target state generation part 220 is transmitted to the moving body 1, and the trajectory generation part 310 of the drive control part 300 generates the trajectory made up of the route and the speed at which the moving body 1 should travel to reach the local target state.

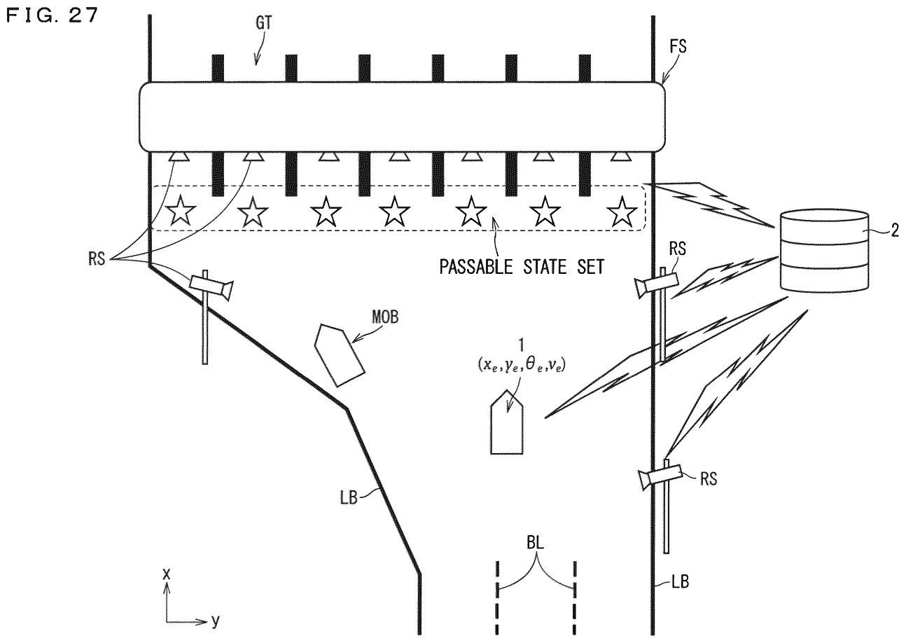

In this manner, in the embodiment 3, the passage point generation apparatus 200 is mounted on the control server 2, and the local target state is transmitted from the control server 2 to the moving body 1 by communication between the control server 2 and the moving body 1. FIG. 27 illustrates a conceptual diagram of this system.

FIG. 27 schematically illustrates a state where the moving body 1 entering a traveling lane in front of the tollgate FS and the control server 2 admissive-controlling the moving body 1 have communication with each other. A plurality of roadside sensors RS are disposed in the tollgate area, and each roadside sensor RS and the moving body 1 have communication with each other via the control server 2.

The travel area information acquisition part 400 of the control server 2 acquires information such as an objective state amount of the moving body 1 and an objective state amount of a moving obstacle MOB in the tollgate area via the plurality of roadside sensors RS.

In this manner, the control server 2 and the moving body 1 have communication with each other, and the state amount of the local target state calculated in the local target state generation part 220 of the passage point generation apparatus 200 in the control server 2 is provided to the moving body 1 by communication. Thus, the local target state generation part 220 generates the target state candidate and the local target state in consideration of communication delay in accordance with the transmission from the control server 2 to the moving body 1.

For example, dynamic reachability of the moving body 1 necessary to calculate the reachable region described using FIG. 5 in the embodiment 1 and the target state candidate such as the virtual trajectory described using FIG. 8 in the embodiment 1 is calculated in consideration of the communication delay by applying not only dynamics of the moving body 1 but also the communication delay to the dynamics model of the expression (7).

In the embodiment 1, the local target state is generated in consideration of not only the dynamics of the moving body but also the communication delay for dynamic reachability of the moving body regarding the calculation of the local target state in FIG. 10 and FIG. 13, for example.

Examples of calculation thereof include a method of locating the position of the local target state on slightly a near side in consideration of follow-up delay due to the communication delay until the moving body reaches the target state candidate.

As described above, the passage point generation apparatus 200 according to the embodiment 3 is mounted on the control server 2. Thus, the calculation processing is not concentrated in the moving body 1 compared with a case where the passage point generation apparatus 200 is mounted on the moving body 1, thus calculation load in the moving body 1 is reduced.

The control server 2 can monitor a larger region than the moving body 1. Thus, the passage point calculated in the passage point generation apparatus 200 using the information recognized in the control server 2 tends to be a more appropriate position than the passage point calculated in the moving body 1.

The control server 2 can transmit instruction of the target state to a plurality of moving bodies, thus the plurality of moving bodies can automatically pass through the gate in a coordinated manner.

The moving body can reach any target state candidate even in a case of admissive control in which communication delay occurs, thus a passage probability of the gate GT of the tollgate is increased.

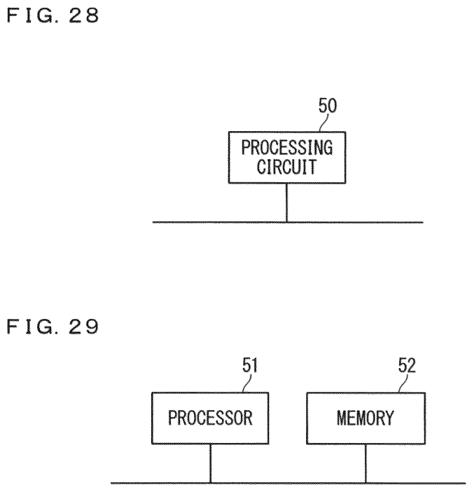

Each constituent element of the passage point generation apparatus 200 according to the embodiments 1 to 3 described above can be made up using a computer, and is achieved when the computer executes a program. That is to say, the passage point generation apparatus 200 is achieved by a processing circuit 50 illustrated in FIG. 28, for example. A processor such as a CPU or a digital signal processor (DSP) is applied to the processing circuit 50, and a function of each part is achieved by executing a program stored in a storage device.

Dedicated hardware can also be applied to the processing circuit 50. When the processing circuit 50 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 50.

In the passage point generation apparatus 200, each of the functions of the constituent elements can be achieved by an individual processing circuit, and these functions can also be collectively achieved by one processing circuit.

FIG. 29 illustrates a hardware configuration in a case where the processing circuit 50 is made up using a processor. In this case, the function of each part of the passage point generation apparatus 200 is achieved by a combination with software etc. (software, firmware, or software and firmware). The software etc. is described as a program and is stored in a memory 52. A processor 51 functioning as the processing circuit 50 reads out and executes a program stored in the memory 52 (storage device), thereby achieving the function of each part. That is to say, this program is deemed to make a computer execute a procedure or a method of the constituent elements of the passage point generation apparatus 200.

Herein, the memory 52 may be a non-volatile or volatile semiconductor memory such as a RAM, a ROM, a flash memory, an erasable programmable read only memory EPROM (EPROM), or an electrically erasable programmable read only memory (EEPROM), a hard disk drive (HDD), a magnetic disc, a flexible disc, an optical disc, a compact disc, a mini disk, a Digital Versatile Disc (DVD), and a drive apparatus thereof, or any storage medium which is to be used in the future.

Described above is the configuration that the function of each constituent element of the passage point generation apparatus 200 is achieved by one of the hardware and the software, for example. However, the configuration is not limited thereto, but also applicable is a configuration of achieving some constituent elements of the passage point generation apparatus 200 by dedicate hardware, and achieving the other some constituent elements by software, for example. For example, functions of some constituent elements can be achieved by the processing circuit 50 as the dedicated hardware and functions of the other some constituent elements can be achieved by the processing circuit 50 as the processor 51 reading out and executing the program stored in the memory 52.

As described above, the passage point generation apparatus 200 can achieve each function described above by the hardware, the software, or the combination of them, for example.

Although the present disclosure is described in detail, the foregoing description is in all aspects illustrative and does not restrict the disclosure. It is therefore understood that numerous modification examples can be devised without departing from the scope of the present disclosure.

In the present disclosure, each embodiment can be arbitrarily combined, or each embodiment can be appropriately varied or omitted within the scope of the disclosure.

1. A passage point generation apparatus generating a passage point which a moving body should reach, comprising:
target state candidate generation circuitry selecting a plurality of target position candidates from a plurality of travelable positions and calculating a plurality of target state candidates including the plurality of target position candidates which has been selected based on surrounding environment information of the moving body and a state amount of the moving body; and
local target state generation circuitry calculating a local target state as a local target state reachable in any of the plurality of target state candidates in an intermediate point of a trajectory toward a surrounding area of the plurality of target state candidates and outputting the local target state as the passage point.

2. The passage point generation apparatus according to claim 1, wherein
the target state candidate generation circuitry generates a set of state amounts in which each of the target states adjacent to each other is within a predetermined range so that the moving body can reach any of the target state candidates when the moving body reaches the local target state.

3. The passage point generation apparatus according to claim 1, wherein
the target state candidate generation circuitry performs calculation so that any of the target state candidates is within a reachable region which the moving body can dynamically reach.

4. The passage point generation apparatus according to claim 1, wherein
the target state candidate generation circuitry performs calculation so that the moving body can reach any of the target state candidates by traveling in consideration of ride quality of the moving body.

5. The passage point generation apparatus according to claim 1, further comprising
global target state generation circuitry generating a more global target state than each target state of the plurality of target state candidates and outputting the target state as a global target state, wherein
the target state candidate generation circuitry performs calculation so that any of the target state candidates can reach the global target state.

6. The passage point generation apparatus according to claim 5, wherein
each of the plurality of target state candidates is a target state for the moving body to pass through a gate of a tollgate, and
the global target state includes at least a state amount of a position to which the moving body proceeds after the moving body passes through the gate of the tollgate.

7. The passage point generation apparatus according to claim 1, wherein
the target state candidate generation circuitry includes:
virtual trajectory generation circuitry generating a plurality of virtual trajectories passing through a plurality of target states;
virtual trajectory evaluation circuitry evaluating the plurality of virtual trajectories based on a dynamics limitation of the moving body; and
target state candidate calculation circuitry calculating the plurality of target states reachable along a virtual trajectory within the limitation as the plurality of target state candidates.

8. The passage point generation apparatus according to claim 1, wherein
the local target state generation circuitry sets an optional position on a virtual trajectory reaching a target state candidate located closest to a center in the plurality of target state candidates calculated in the target state candidate calculation circuitry in the plurality of virtual trajectories to the local target state.

9. The passage point generation apparatus according to claim 1, wherein
the local target state generation circuitry limits a change of the local target state immediately before the moving body reaches the local target state.

10. The passage point generation apparatus according to claim 1, wherein
the local target state generation circuitry performs weighting on the plurality of target state candidates based on a predetermined evaluation index, and calculates the local target state based on a value of a weight.

11. The passage point generation apparatus according to claim 7, wherein
the target state candidate generation circuitry provides scores to the plurality of virtual trajectories based on a predetermined evaluation index, compares a score provided to each virtual trajectory and a threshold value, and sets a point where the moving body travels along the virtual trajectory having a score equal to or larger than the threshold value or smaller than the threshold value to the plurality of target state candidates.

12. The passage point generation apparatus according to claim 7, wherein
the local target state generation circuitry performs weighting on a virtual trajectory reaching the plurality of target state candidates calculated in the target state candidate calculation circuitry in in the plurality of virtual trajectories, and sets a state where a weighted average of an optional position on the virtual trajectory and a weight is obtained to the local target state.

13. The passage point generation apparatus according to claim 1, wherein
the passage point generation apparatus is mounted on a control apparatus admissive-controlling the moving body by communication with the moving body, and
the local target state generation circuitry calculates the local target state so that the moving body can reach any of the target state candidates in consideration of communication delay of admissive control.
